(19) United States
(12) Patent Application Publication
(10) Pub. No.: US 2011/0184903 A1
(43) Pub. Date: Jul. 28, 2011

(54) Operation System For Providing Backup Batteries For Hybrid Vehicles And/Or Electric Vehicles And Method Thereof

(76) Inventor: Liam-Yung Sung, Shihlin (TW)

(21) Appl. No.: 12/762,304

(22) Filed: Apr. 17, 2010

Related U.S. Application Data
(60) Provisional application No. 61/298,288, filed on Jan. 26, 2010.

(51) Int. Cl. G06N 5/02; H02J 7/00

(52) U.S. Cl. 706/50; 320/109; 706/46

(57) ABSTRACT

An operation system for providing backup batteries for hybrid vehicles and/or electric vehicles and a method thereof are provided. In accordance with the present invention, information and data related to backup batteries demanded for driving the gas-electric hybrid vehicles or electric vehicle to moves are obtained and processed, and according to the processed information and data, a service end provides backup batteries for replacing the original batteries for further driving the vehicle to move. When the vehicles at the client end lack electric power for further driving, they no longer need to wait to the have their batteries charged. Instead, backup batteries having sufficient electric power stored therein are provided for replacement to provide electric power for further driving.

### BACKGROUND OF THE INVENTION

1. Field of the Invention

The present invention relates generally to an operation system for providing backup batteries for hybrid vehicles and/or electric vehicles and a method thereof. Particularly, in accordance with the present invention, when electric power stored in a battery being used for driving a hybrid vehicle or an electric vehicle is insufficient for the vehicle and the vehicle needs additional electric power for being further driven, a backup battery having sufficient electric power stored therein is provided for replacing the battery having insufficient electric power. In such a way, the vehicle does not need to wait for charging the battery, and can immediately obtain the demanded electric power.

2. The Prior Arts

In the current automotive industry, responsive to the environmental protection demand, and for the purpose of reducing the exhaust emission, and decreasing the dependency of the industry on fossil fuel, gas-electric hybrid vehicles and electric vehicles have been developed. Accordingly, in addition to the conventional gas/diesel fuel, electric power becomes a further option of power for driving a vehicle.

In a typical hybrid vehicle or electric vehicle, a battery is usually equipped for providing an electric power for driving the vehicle. However, when the electric power saved in the battery is insufficient for driving the vehicle, the vehicle must be stopped and wait a long time for having the battery charged. That means, the insufficiency of electric power of the battery cannot be instantly solved, and this often causes disturbance and inconvenience to the user. Therefore, some prospective customers may worry about the inconvenience and be reluctant to buy such a vehicle.

As such, an operation system for providing backup batteries for hybrid vehicles and/or electric vehicles and a method thereof are highly demanded for driving a hybrid vehicle or an electric vehicle. According to the operation system for providing backup batteries for hybrid vehicles and/or electric vehicles and the method of the present invention, when the electric power stored in a battery is out of electric power, the vehicle does not need to wait to have the battery charged. On the contrary, the vehicle can instantly be provided with replacement electric power.

### SUMMARY OF THE INVENTION

A primary objective of the present invention is to provide an operation system for providing backup batteries for hybrid vehicles and/or electric vehicles and a method thereof. In accordance with the present invention, when electric power stored in a battery used for driving a vehicle of a client end is insufficient, the vehicle does not need waiting to have the battery charged. Instead, a backup battery having sufficient electric power stored therein is instantly provided for replacing the original battery having insufficient electric power. In such a way, the insufficiency of electric power for driving the vehicle can be instantly solved without waiting to have the battery charged.

A further objective of the present invention is to provide an operation system for providing backup batteries for hybrid vehicles and/or electric vehicles and a method thereof. In accordance with the present invention, information and data related to backup batteries demanded for driving the gas-electric hybrid vehicles or electric vehicles to move are processed, and according to the processed information and data, a service end provides backup batteries for replacing the original batteries for further driving the vehicles to move.

For achieving the foregoing objectives and others, the present invention provides an operation system for providing backup batteries for hybrid vehicles and/or electric vehicles and a method thereof. The operation system includes an evaluating/processing module, a backup battery management module, and a database.

The evaluating/processing module is adapted for obtaining information and data related to one or more backup batteries to be provided by the backup battery management module to one of more of the hybrid vehicles or electric vehicles at the client end from the database or a third party. According to a certain processing logic, the evaluating/processing module analyzes, evaluates, and processes the information and data so as to obtain a quantity of demanded backup batteries. Then, the processed data and information and/or the obtained quantity of demanded backup batteries are forwarded to the backup battery management module and/or the third party, and/or saved in the database. According to an aspect of the embodiment the processing logic is positioned in the evaluating/processing module, and/or in the database.

The backup battery management module is adapted for instantly or procedurally controlling, operating, and managing a plurality of backup batteries at a service end for backing up a plurality of hybrid vehicles and/or electric vehicles at the client end, in accordance with the processed information and data received from the evaluating/processing module and/or in accordance with information and data of a dynamic inventory management of the backup batteries from the third party, and then providing the backup batteries to the hybrid vehicles and/or electric vehicles for replacing the original batteries being used by the hybrid vehicles and/or electric vehicles and having insufficient electric power stored therein, so that the hybrid vehicles and/or electric vehicles at the client end can obtain demanded backup batteries in time for further driving operation. The backup battery management module also instantly or procedurally saves information and data related to the operation situation of replacing batteries in the database and/or forwards the same to the evaluating/processing module and/or the third party, so as to allow the evaluating/processing module and/or the third party to dynamically obtain an instant value of the quantity of demanded backup batteries, thus determining whether or not the amount of the backup batteries should be increased/decreased. The backup batteries can be provided either by the third party, or by the operation system. In such a way, when the hybrid vehicles and/or electric vehicles demand for additional electric power, they no longer need to wait to have their batteries charged. Instead, backup batteries having sufficient electric power stored are provided for replacing the previously used batteries having insufficient electric power. In other words, when hybrid vehicles and/or electric vehicles at the client end demand for additional electric power, the backup batteries at the service end are provided for replacing the previously used batteries having insufficient electric power.

As to the database, it is adapted for saving the information and data related to the backup batteries demanded by the hybrid vehicles and/or electric vehicles of the client end by the backup battery management module, and saving the processed information and data, and/or the information and data related to the quantity of the demanded backup batteries. According to an aspect of the embodiment, the database is also adapted for saving the processing logic of the evaluating/processing module. Furthermore, the database can also save the information and data related to the operation situation of replacing batteries forwarded from the backup battery management module, such that the evaluating/processing module can subsequently estimate the quantity of backup batteries demanded by the backup battery management module, thus determining whether or not the amount of the backup batteries should be increased or decreased.

According to an aspect of the embodiment, the evaluating/processing module, and/or the backup battery management module of the operation system of the present invention can be realized in a manner of software, and/or firmware, and/or hardware, in accordance with the practical demand.

In operation, when the operation system of the present invention is used for management, at first, the evaluating/processing module analyzes, evaluates, and processes the information and data related to the backup batteries demanded by the hybrid vehicles and/or electric vehicles at the client end by the backup battery management module obtained from the database and/or the third party in accordance with the processing logic, so as to obtain the quantity of the demanded backup batteries. Then, the processed data and information and/or the obtained quantity of the demanded backup batteries are forwarded to the backup battery management module and/or the third party, and/or saved in the database.

Then, the backup battery management module instantly or procedurally controls, operates, and manages the backup batteries at the service end for backing up a plurality of hybrid vehicles and/or electric vehicles at the client end, in accordance with the processed information and data received from the evaluating/processing module and/or in accordance with information and data of a dynamic inventory management of the backup batteries from the third party, and then provides the backup batteries to the hybrid vehicles and/or electric vehicles for replacing the original batteries being used by the hybrid vehicles and/or electric vehicles and having insufficient electric power saved therein, so that the hybrid vehicles and/or electric vehicles at the client end can obtain demanded backup batteries in time for further driving operation.

The backup battery management module also instantly or procedurally saves information and data related to the operation situation of replacing batteries in the database and/or forwards the same to the evaluating/processing module and/or the third party, so as to allow the evaluating/processing module and/or the third party to dynamically obtain an instant value of the quantity of demanded backup batteries, thus determining whether or not the amount of the backup batteries should be increased/decreased. The backup batteries can be provided either by the third party, or by the operation system. In such a way, when the hybrid vehicles and/or electric vehicles demand for additional electric power, they no longer need to wait to have their batteries charged. Instead, backup batteries having sufficient electric power stored are provided for replacing the previously used batteries having insufficient electric power. In other words, when hybrid vehicles and/or electric vehicles at the client end demand for additional electric power, the backup batteries at the service end are provided for replacing the previously used batteries having insufficient electric power.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a system architecture of the operation system according to an embodiment of the present invention;

FIG. 2 is a flow chart illustrating the operation procedure of the operation system according to an embodiment of the present invention;

FIG. 3 is a schematic diagram illustrating an operation system according to an embodiment of the present invention;

FIG. 4 is a flow chart illustrating the operation procedure of the operation system according to the embodiment of FIG. 3;

FIG. 5 is a schematic diagram illustrating an operation system according to an embodiment of the present invention; and

FIG. 6 is a flow chart illustrating the operation procedure of the operation system according to the embodiment of FIG. 5.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

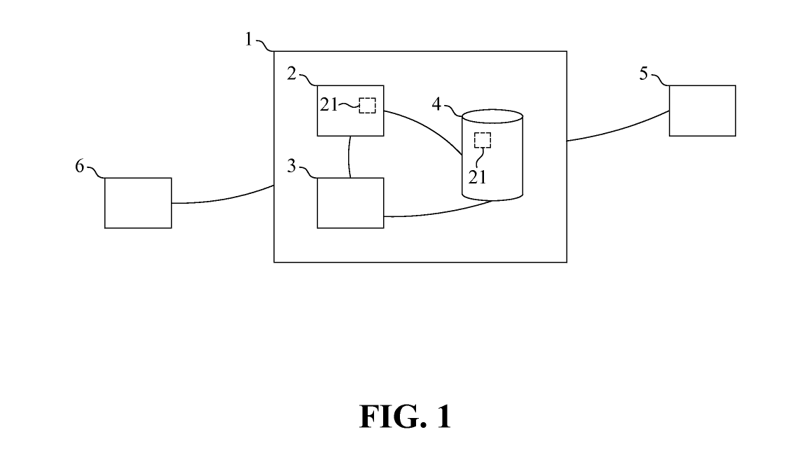

FIG. 1 is a schematic diagram illustrating a system architecture of the operation system according to an embodiment of the present invention. Referring to FIG. 1, there is shown an operation system 1 including an evaluating/processing module 2, a backup battery management module 3, and a database 4. The operation system 1 is adapted for providing backup batteries having sufficient electric power stored therein at a service end (not shown) to hybrid vehicles and/or electric vehicles at a client end 6 for replacing batteries being used by the hybrid vehicles and/or electric vehicles and having insufficient electric power.

The evaluating/processing module 2 is adapted for obtaining information and data (not shown in the drawings) related to one or more backup batteries to be provided by the backup battery management module 3 to one of more of the hybrid vehicles or electric vehicles at the client end 6 from the database 4 and/or a third party 5. According to a certain processing logic 21, the evaluating/processing module 2 analyzes, evaluates, and processes the information and data so as to obtain a quantity of demanded backup batteries. Then, the processed data and information and/or the obtained quantity of demanded backup batteries are forwarded to the backup battery management module 3 and/or the third party 5, and/or saved into the database 4. According to an aspect of the embodiment the processing logic 21 is positioned in the evaluating/processing module 2, and/or in the database 4.

The backup battery management module 3 is adapted for instantly or procedurally controlling, operating, and managing a plurality of backup batteries (not shown in the drawings) at the service end for backing up a plurality of hybrid vehicles and/or electric vehicles (not shown in the drawings) at the client end 6, in accordance with the processed information and data received from the evaluating/processing module 2 and/or in accordance with information and data of a dynamic inventory management of the backup batteries from the third party 5, and then providing the backup batteries to the hybrid vehicles and/or electric vehicles for replacing the original batteries being used by the hybrid vehicles and/or electric vehicles and having insufficient electric power stored therein, so that the hybrid vehicles and/or electric vehicles at the client end 6 can obtain demanded backup batteries in time for further driving operation. The backup battery management module 3 also instantly or procedurally saves the information and data related to the operation situation of replacing batteries in the database 4 and/or forwards the same to the evaluating/processing module 2 and/or the third party 5, so as to allow the evaluating/processing module 2 and/or the third party 5 to dynamically obtain an instant value of the quantity of demanded backup batteries, thus determining whether or not the amount of the backup batteries should be increased/decreased. The backup batteries can be provided either by the third party 5, or by the operation system 1. In such a way, when the hybrid vehicles and/or electric vehicles at the client end 6 demand for additional electric power, they no longer need to wait to have their batteries charged. Instead, backup batteries having sufficient electric power stored are provided for replacing the previously used batteries having insufficient electric power. In other words, when the hybrid vehicles and/or electric vehicles at the client end 6 demand for additional electric power, the backup batteries at the service end are provided for replacing the previously used batteries having insufficient electric power.

The database 4 is adapted for saving the information and data related to the backup batteries demanded by the hybrid vehicles and/or electric vehicles of the client end 6 by the backup battery management module 3, and saving the information and data processed by the evaluating/processing module 2, and/or the information and data related to the quantity of the demanded backup batteries. According to an aspect of the embodiment, the database 4 is also adapted for saving the processing logic of the evaluating/processing module 2. Furthermore, the database 4 can also save the information and data related to the operation situation of replacing batteries forwarded from the backup battery management module 3, such that the evaluating/processing module 2 can subsequently estimate the quantity of backup batteries demanded by the backup battery management module 3, thus determining whether or not the amount of the backup batteries should be increased or decreased.

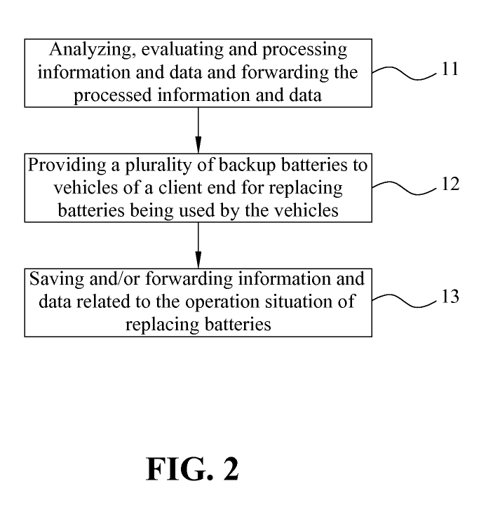

FIG. 2 is a flow chart illustrating the operation procedure of the operation system according to an embodiment of the present invention. Referring to FIG. 2, at step 11, the evaluating/processing module 2 analyzes, evaluates, and processes the information and data related to the backup batteries to be provided by the backup battery management module 3 to the hybrid vehicles and/or electric vehicles at the client end 6 obtained from the database 4 and/or the third party 5 in accordance with the processing logic 21, so as to obtain the quantity of the demanded backup batteries. Then, the processed data and information and/or the obtained quantity of the demanded backup batteries are forwarded to the backup battery management module 3 and/or the third party 5, and/or saved into the database 4. Then, the flow goes to step 12.

At step 12, the backup battery management module 3 instantly or procedurally controls, operates, and manages the backup batteries at the service end for backing up a plurality of hybrid vehicles and/or electric vehicles (not shown in the drawings) at the client end 6, in accordance with the processed information and data received from the evaluating/processing module 2 and/or in accordance with information and data of a dynamic inventory management of the backup batteries from the third party 5, and then provides the backup batteries to the hybrid vehicles and/or electric vehicles for replacing the original batteries being used by the hybrid vehicles and/or electric vehicles and having insufficient electric power saved therein, so that the hybrid vehicles and/or electric vehicles at the client end 6 can obtain demanded backup batteries in time for further driving operation. Then, the flow goes to step 13.

At step 13, the backup battery management module 3 also instantly or procedurally saves information and data (not shown in the drawings) related to the operation situation of replacing batteries into the database 4 and/or forwards the same to the evaluating/processing module 2 and/or the third party 5, so as to allow the evaluating/processing module 2 and/or the third party 5 to dynamically obtain an instant value of the quantity of demanded backup batteries, thus determining whether or not the amount of the backup batteries should be increased/decreased.

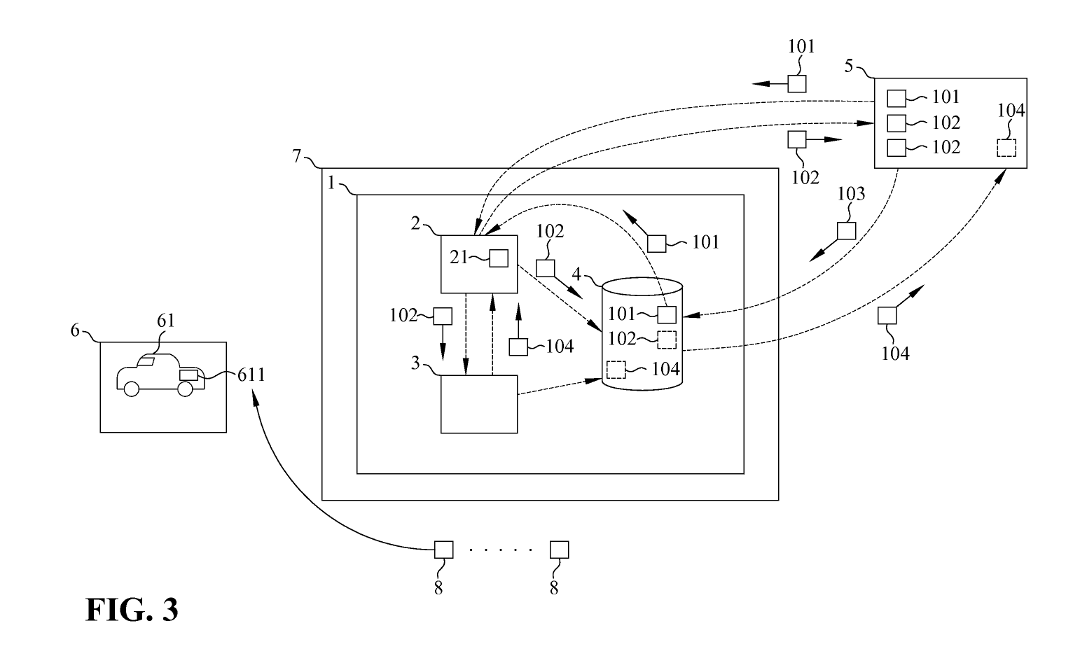

FIG. 3 is a schematic diagram illustrating an operation system according to an embodiment of the present invention. Referring to FIG. 3, there is shown an operation system 1. The operation system is positioned in a service end 7, and includes an evaluating/processing module, 2, a backup battery management module 3, and a database 4. The service end 7 contains a plurality of backup batteries 8 adapted for being provided to hybrid vehicles and/or electric vehicles 61 at the client end 6 for replacing batteries being used and having insufficient electric power.

The evaluating/processing module 2 is adapted for obtaining information and data 101 related to backup batteries to be provided by the backup battery management module 3 to the hybrid vehicles or electric vehicles 61 at the client end 6 from the database 4 and/or a third party 5. According to a certain processing logic 21, the evaluating/processing module 2 analyzes, evaluates, and processes the obtained information and data so as to obtain a quantity of demanded backup batteries. Then, information and data 102 related to the obtained quantity of demanded backup batteries are forwarded to the backup battery management module 3 and/or the third party 5, and/or saved into the database 4. According to an aspect of the embodiment the processing logic 21 is positioned in the evaluating/processing module 2.

The backup battery management module 3 is adapted for instantly or procedurally controlling, operating, and managing the backup batteries 8 of the service end 7 for backing up the hybrid vehicles and/or electric vehicles 61 at the client end 6, in accordance with the processed information and data 102 received from the evaluating/processing module 2 and/or in accordance with information and data 103 of a dynamic inventory management of the backup batteries 8 from the third party 5, and then providing the backup batteries 8 to the hybrid vehicles and/or electric vehicles 61 for replacing the original batteries 611 being used by the hybrid vehicles and/or electric vehicles 61 and having insufficient electric power stored therein, so that the hybrid vehicles and/or electric vehicles 61 at the client end 6 can obtain demanded backup batteries 8 in time for further driving operation. The backup battery management module 3 also instantly or procedurally saves the information and data 104 related to the operation situation of replacing batteries into the database 4 and/or forwards the same to the evaluating/processing module 2 and/or the third party 5, so as to allow the evaluating/processing module 2 and/or the third party 5 to dynamically obtain an instant value of the quantity of the demanded backup batteries 8, thus determining whether or not the amount of the backup batteries 8 should be increased/decreased. The backup batteries are provided by the third party 5. In such a way, when the hybrid vehicles and/or electric vehicles 61 at the client end 6 demand for additional electric power, they no longer need to wait to have their batteries charged. Instead, backup batteries 8 having sufficient electric power stored are provided for replacing the previously used batteries 611 having insufficient electric power. In other words, when the hybrid vehicles and/or electric vehicles 61 at the client end 6 demand for additional electric power, the backup batteries 8 at the service end 7 are provided for replacing the previously used batteries 611 having insufficient electric power.

The database 4 is adapted for saving the information and data 101 related to the backup batteries 8 demanded by the hybrid vehicles and/or electric vehicles 61 of the client end 6 by the backup battery management module 3, and saving the information and data 102 related to the quantity of the demanded backup batteries 8. Furthermore, the database 4 can also save the information and data 104 related to the operation situation of replacing batteries forwarded from the backup battery management module 3, such that the evaluating/processing module 2 can subsequently estimate the quantity of the backup batteries 8 demanded by the backup battery management module 3, thus determining whether or not the amount of the backup batteries 8 should be increased or decreased.

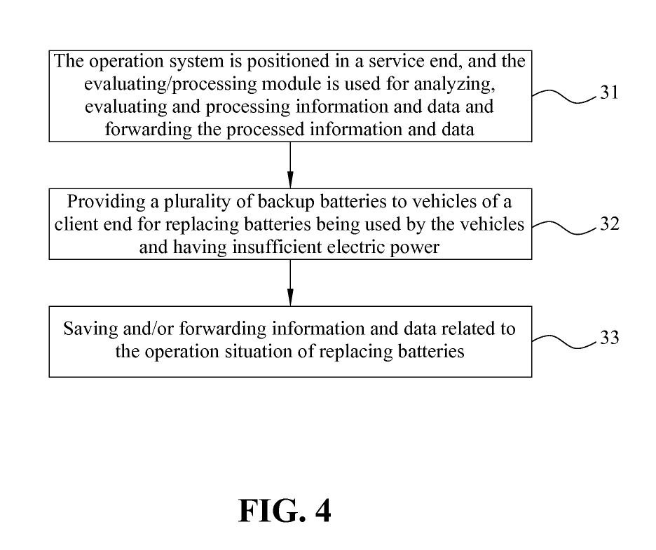

FIG. 4 is a flow chart illustrating the operation procedure of the operation system according to the embodiment of FIG. 3. Referring to FIG. 4, at step 31, the evaluating/processing module 2 analyzes, evaluates, and processes the information and data 101 related to the backup batteries to be provided by the backup battery management module 3 to the hybrid vehicles and/or electric vehicles 61 at the client end 6 obtained from the database 4 and/or the third party 5 in accordance with the processing logic 21, so as to obtain the quantity of the demanded backup batteries. Then, the processed data and information 102 related to the obtained quantity of the demanded backup batteries are forwarded to the backup battery management module 3 and/or the third party 5, and/or saved into the database 4. Then, the flow goes to step 32.

At step 32, the backup battery management module 3 instantly or procedurally controls, operates, and manages the backup batteries 8 at the service end 7 for backing up a plurality of hybrid vehicles and/or electric vehicles 61 at the client end 6, in accordance with the processed information and data 102 received from the evaluating/processing module 2 and/or in accordance with information and data 103 of a dynamic inventory management of the backup batteries 8 from the third party 5, and then provides the backup batteries 8 to the hybrid vehicles and/or electric vehicles 61 for replacing the original batteries 611 being used by the hybrid vehicles and/or electric vehicles 61 and having insufficient electric power saved therein, so that the hybrid vehicles and/or electric vehicles 61 at the client end 6 can obtain demanded backup batteries in time for further driving operation. Then, the flow goes to step 33.

At step 33, the backup battery management module 3 also instantly or procedurally saves information and data 104 related to the operation situation of replacing batteries into the database 4 and/or forwards the same to the evaluating/processing module 2 and/or the third party 5, so as to allow the evaluating/processing module 2 and/or the third party 5 to dynamically obtain an instant value of the quantity of demanded backup batteries 8, thus determining whether or not the amount of the backup batteries should be increased/decreased. The database 4 saves the information and data 104 related to the operation situation of replacing batteries, so as to allow the evaluating/processing module 2 to dynamically obtain an instant value of the quantity of demanded backup batteries 8, thus determining whether or not the amount of the backup batteries should be increased/decreased.

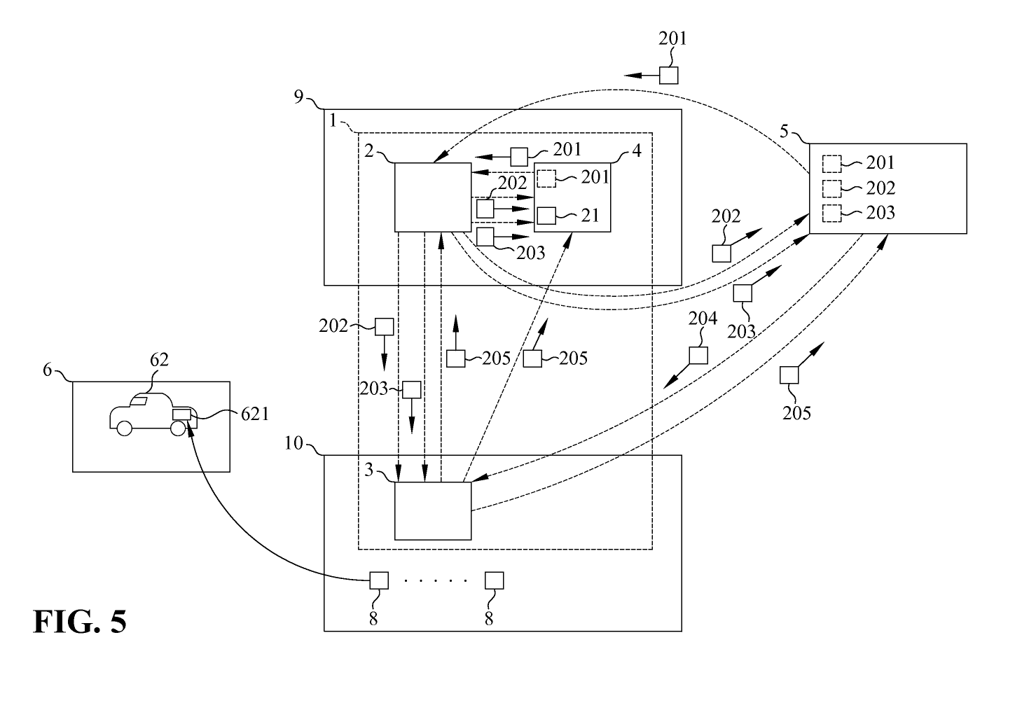

FIG. 5 is a schematic diagram illustrating an operation system according to an embodiment of the present invention. Referring to FIG. 5, there is shown an operation system 1. The operation system includes an evaluating/processing module, 2, a backup battery management module 3, and a database 4. The evaluating/processing module 2 and the database 4 are positioned in a server 9, and the backup battery management module 3 is positioned at a battery charging station 10. The battery charging station 10 is equivalent to the service end 7 of the foregoing embodiment. The battery charging station 10 contains a plurality of backup batteries 8 adapted for being provided to hybrid vehicles and/or electric vehicles 61 at the client end 6 for replacing batteries 621 being used and having insufficient electric power.

The evaluating/processing module 2 located in the server 9 is adapted for obtaining information and data 201 related to backup batteries 8 to be provided by the backup battery management module 3 to the hybrid vehicles or electric vehicles 62 at the client end 6 from the database 4 and/or a third party 5. According to a certain processing logic 21, the evaluating/processing module 2 analyzes, evaluates, and processes the obtained information and data 201 so as to obtain a quantity of demanded backup batteries 8. Then, information and data 202 related to the obtained quantity of demanded backup batteries 8 are forwarded to the backup battery management module 3 and/or the third party 5, and/or saved into the database 4. According to an aspect of the embodiment the processing logic 21 is positioned in the database 2.

The backup battery management module 3 located in the battery charging station 10 is adapted for instantly or procedurally controlling, operating, and managing the backup batteries 8 of the battery charging station 10 for backing up the hybrid vehicles and/or electric vehicles 62 at the client end 6, in accordance with the processed information and data 202 received from the evaluating/processing module 2 and/or in accordance with information and data 203 related to the quantity of demanded backup batteries 8, and/or information and data of a dynamic inventory management of the backup batteries 8 from the third party 5, and then providing the backup batteries 8 to the hybrid vehicles and/or electric vehicles 62 for replacing the original batteries 621 being used by the hybrid vehicles and/or electric vehicles 62 and having insufficient electric power stored therein, so that the hybrid vehicles and/or electric vehicles 62 at the client end 6 can obtain demanded backup batteries 8 in time for further driving operation. The backup battery management module 3 also instantly or procedurally saves the information and data 205 related to the operation situation of replacing batteries into the database 4 and/or forwards the same to the evaluating/processing module 2 and/or the third party 5, so as to allow the evaluating/processing module 2 and/or the third party 5 to dynamically obtain an instant value of the quantity of demanded backup batteries 8, thus determining whether or not the amount of the backup batteries 8 should be increased/decreased. The backup batteries 8 are provided by the battery charging station 10. In such a way, when the hybrid vehicles and/or electric vehicles 62 at the client end 6 demand for additional electric power, they no longer need to wait to have their batteries charged. Instead, backup batteries 8 having sufficient electric power stored are provided for replacing the previously used batteries 621 having insufficient electric power. In other words, when the hybrid vehicles and/or electric vehicles 62 at the client end 6 demand for additional electric power, the backup batteries 8 in the battery charging station 10 are provided for replacing the previously used batteries 621 having insufficient electric power.

The database 4 is adapted for saving the information and data 201 related to the backup batteries 8 demanded by the hybrid vehicles and/or electric vehicles 61 of the client end 6 by the backup battery management module 3, the processed information and data 202 which are processed by the evaluating/processing module 2, and the information and data 203 related to the quantity of the demanded backup batteries 8. Further, the database 4 is also adapted for saving the processing logic 21 of the evaluating/processing module. Furthermore, the database 4 can also save the information and data 205 related to the operation situation of replacing batteries forwarded from the backup battery management module 3, such that the evaluating/processing module 2 can subsequently estimate the quantity of backup batteries 8 demanded by the backup battery management module 3, thus determining whether or not the amount of the backup batteries 8 should be increased or decreased.

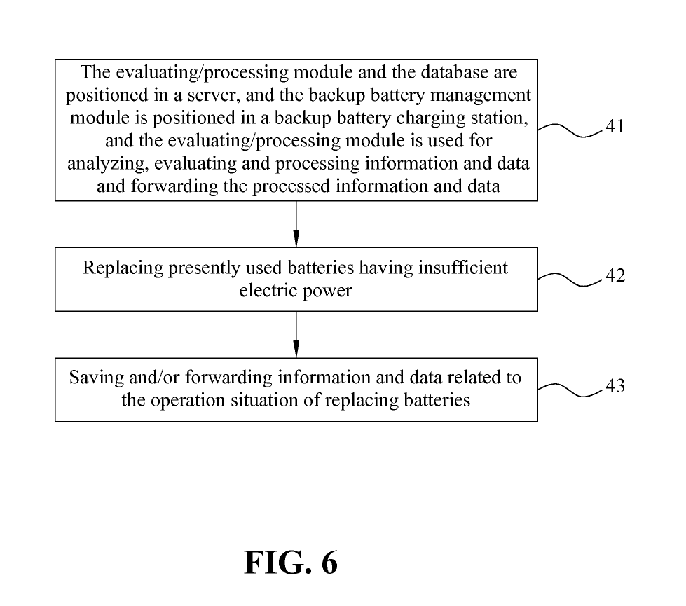

FIG. 6 is a flow chart illustrating the operation procedure of the operation system according to the embodiment of FIG. 5. Referring to FIG. 6, at step 41, the evaluating/processing module 2 located in the server 9 analyzes, evaluates, and processes the information and data 201 related to backup batteries 8 to be provided by the backup battery management module 3 to the hybrid vehicles or electric vehicles 62 at the client end 6 from the database 4 and/or a third party 5, in accordance with the processing logic 21, so as to obtain the quantity of the demanded backup batteries 8. Then, the processed data and information 202 and the information and data 203 related to the quantity of the demanded backup batteries 8 are forwarded to the backup battery management module 3 and/or the third party 5, and/or saved into the database 4. Then, the flow goes to step 32.

At step 42, the backup battery management module 3 located in the battery charging station 10 instantly or procedurally controls, operates, and manages the backup batteries 8 in the battery charging station 10 for backing up a plurality of hybrid vehicles and/or electric vehicles 62 at the client end 6, in accordance with the processed information and data 202 received from the evaluating/processing module 2 and/or in accordance with the information and data 203 related to the quantity of the demanded backup batteries 8, and or in accordance with the information and data 204 of a dynamic inventory management of the backup batteries 8 from the third party 5, and then provides the backup batteries 8 to the hybrid vehicles and/or electric vehicles 62 for replacing the original batteries 621 being used by the hybrid vehicles and/or electric vehicles 62 and having insufficient electric power saved therein, so that the hybrid vehicles and/or electric vehicles 62 at the client end 6 can obtain demanded backup batteries 8 in time for further driving operation. Then, the flow goes to step 43.

At step 43, the backup battery management module 3 also instantly or procedurally saves information and data 204 related to the operation situation of replacing batteries into the database 4 and/or forwards the same to the evaluating/processing module 2 and/or the third party 5, so as to allow the evaluating/processing module 2 and/or the third party 5 to dynamically obtain an instant value of the quantity of demanded backup batteries 8, thus determining whether or not the amount of the backup batteries should be increased/decreased. The database 4 saves the information and data 205 related to the operation situation of replacing batteries, so as to allow the evaluating/processing module 2 to dynamically obtain an instant value of the quantity of demanded backup batteries 8, thus determining whether or not the amount of the backup batteries should be increased/decreased.

In summary, the present invention provides an operation system for providing backup batteries for hybrid vehicles and/or electric vehicles and a method thereof. In accordance with the present invention, information and data related backup batteries demanded by the hybrid vehicles and/or electric vehicles are analyzed and estimated. Then, according to the processed information and data, the demanded backup batteries are provided at the service end. In such a way, when the vehicles at the client end demand for additional or backup electric power, they no longer need to wait to the have their batteries charged. Instead, backup batteries having sufficient electric power stored therein are provided for replacement to provide electric power for further driving. Comparing to the conventional technology, the present invention has the following advantages:

(1) When the vehicles at the client end lack electric power for further driving, they no longer need to wait to the have their batteries charged. Instead, backup batteries having sufficient electric power stored therein are provided for replacement to provide electric power for further driving; and

(2) The information and data related backup batteries demanded by the hybrid vehicles and/or electric vehicles are analyzed and estimated, and according to the processed information and data, the demanded backup batteries are provided at the service end for replacing the original batteries having insufficient electric power.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An operation management method, adapted for providing a plurality of backup batteries to a plurality of hybrid vehicles and/or electric vehicles, comprising:
analyzing and estimating information and data related to backup batteries demanded by the hybrid vehicles and/or electric vehicles, to obtain a quantity of the demanded backup batteries; and
instantly and/or procedurally controlling, operating, and managing the backup batteries, and providing the demanded backup batteries to the hybrid vehicles and/or electric vehicles in accordance with the quantity of the demanded backup batteries, wherein the provided backup batteries are provided for replacing original batteries of the hybrid vehicles and/or electric vehicles having insufficient electric power.

2. The operation management method as claimed in claim 1, further comprising:
determining whether or not to increase or decrease an amount of the backup batteries, in accordance with the quantity of the demanded backup batteries demanded by the hybrid vehicles and/or electric vehicles.

3. An operation management method, adapted for providing a plurality of backup batteries to a plurality of hybrid vehicles and/or electric vehicles, comprising:
analyzing and estimating information and data related to backup batteries demanded by the hybrid vehicles and/or electric vehicles, according to a processing logic, to obtain a quantity of the demanded backup batteries; and
instantly and/or procedurally controlling, operating, and managing the backup batteries, and providing the demanded backup batteries to the hybrid vehicles and/or electric vehicles in accordance with the processed information and data and/or in accordance with information and data of a dynamic inventory management of the backup batteries, wherein the provided backup batteries are provided for replacing original batteries of the hybrid vehicles and/or electric vehicles having insufficient electric power.

4. The operation management method as claimed in claim 3, further comprising:
determining whether or not to increase or decrease an amount of the backup batteries, in accordance with the quantity of the demanded backup batteries demanded by the hybrid vehicles and/or electric vehicles.

5. An operation management method, adapted for providing a plurality of backup batteries of a service end to a plurality of hybrid vehicles and/or electric vehicles of a client end, comprising:
using an evaluating/processing module to obtain information and data related to demanded backup batteries to be provided by a backup battery management module to the hybrid vehicles and/or electric vehicles from a database and/or a third party, and analyze, estimate, and process the obtained information and data according to a processing logic, to obtain a quantity of the demanded backup batteries, wherein the processed information and data and/or information and data related to the quantity of the demanded backup batteries are forwarded to the backup battery management module and/or the third party, and/or saved in the database;
using the backup battery management module to instantly and/or procedurally control, operate, and manage the backup batteries at the service end, and providing the demanded backup batteries from the service end to the hybrid vehicles and/or electric vehicles at the client end in accordance with the processed information and data from the evaluating/processing module and/or in accordance with information and data of a dynamic inventory management of the backup batteries of the service end from a third party, wherein the provided backup batteries are provided for replacing original batteries of the hybrid vehicles and/or electric vehicles having insufficient electric power; and
using the backup battery management module to instantly and/or procedurally save information and data related to operation situation of replacing batteries into the database and/or forward the information and data related to operation situation of replacing batteries to the evaluating/processing module and/or the third party so as to allow the evaluating/processing module and/or the third party to obtain a quantity of backup batteries demanded by the backup battery management module, thus determining whether or not to increase or decrease an amount of the backup batteries.

6. The operation management method as claimed in claim 5, further comprising:
the database saving the information and data related to the operation situation of replacing batteries from the backup battery management module, and the evaluating/processing module subsequently evaluating the quantity of backup batteries demanded by the backup battery management module, and determining whether or not to increase or decrease an amount of the backup batteries.

7. The operation management method as claimed in claim 5, wherein the backup batteries of the service end are provided by the third party.

8. The operation management method as claimed in claim 5, wherein the evaluating/processing module and the database are positioned in a server.

9. The operation management method as claimed in claim 5, wherein the backup battery management module is positioned in a battery charging station.

10. An operation system adapted for providing a plurality of backup batteries to a plurality of hybrid vehicles and/or electric vehicles, comprising:
an evaluating/processing module, adapted for analyzing and estimating information and data related to backup batteries demanded by the hybrid vehicles and/or electric vehicles, for obtaining a quantity of the demanded backup batteries, and forwarding the processed information and data; and
a backup battery management module, adapted for receiving the processed information and data from the evaluating/processing module, and instantly and/or procedurally controlling, operating, and managing the backup batteries, and providing the backup batteries to the hybrid vehicles and/or electric vehicles, wherein the provided backup batteries are provided for replacing original batteries of the hybrid vehicles and/or electric vehicles having insufficient electric power.

11. An operation system adapted for providing a plurality of backup batteries to a plurality of hybrid vehicles and/or electric vehicles, comprising:
an evaluating/processing module, adapted for analyzing and estimating information and data related to backup batteries demanded by the hybrid vehicles and/or electric vehicles, for obtaining a quantity of the demanded backup batteries, and forwarding the processed information and data; and
a backup battery management module, adapted for receiving the processed information and data from the evaluating/processing module, and instantly and/or procedurally controlling, operating, and managing the backup batteries, and providing the backup batteries to the hybrid vehicles and/or electric vehicles, wherein the provided backup batteries are provided for replacing original batteries of the hybrid vehicles and/or electric vehicles having insufficient electric power, and the backup battery management module instantly and/or procedurally forwards the information and data related to the operation situation of replacing batteries.

12. The operation system as claimed in claim 10, further comprising:
a database, adapted for saving the processed information and data.

13. The operation system as claimed in claim 11, further comprising:
a database, adapted for saving the processed information and data, and adapted for saving the information and data related to the operation situation of replacing batteries from the backup battery management module, for allowing the evaluating/processing module to subsequently obtain the quantity of backup batteries demanded by the backup battery management module, thus determining whether or not to increase or decrease an amount of the backup batteries.

14. The operation system as claimed in claim 12, wherein the backup batteries of the service end are provided by the third party.

15. The operation system as claimed in claim 12, wherein the evaluating/processing module and the database are positioned in a server.

16. The operation system as claimed in claim 12, wherein the backup battery management module is positioned in a battery charging station.
